(19) United States
(12) Patent Application Publication
(10) Pub. No.: US 2023/0141908 A1
(43) Pub. Date: May 11, 2023

(54) DOOR OPENING AND CLOSING APPARATUS

(71) Applicant: U-Shin Ltd., Nagano (JP)

(72) Inventor: Tetsuo TOKUDOME, Hiroshima (JP)

(21) Appl. No.: 17/918,235

(22) PCT Filed: Apr. 8, 2021
(86) PCT No.: PCT/JP2021/014888

§ 371 Date: Oct. 11, 2022

(30) Foreign Application Priority Data
Apr. 17, 2020 (JP) 2020-074308

(51) Int. Cl. E05F 15/76; B60J 5/04

(52) U.S. Cl. CPC E05F 15/76; B60J 5/04; E05Y 2900/531

(57) ABSTRACT

The door opening and closing apparatus includes: a first drive unit that opens and closes a front side door; a second drive unit that opens and closes a rear side door; a first detection section that repeatedly detects a distance to a first detection object present in a first detection range; a second detection section that repeatedly detects a distance to a second detection object present in a second detection range; and a control unit that opens and closes the side doors when a moving object being the detection object has performed predetermined movements Ma to Mc having a plurality of stages. The control unit determines from which one of the rear, the front, and the side of a vehicle body the moving object is approaching, and executes one of first processing of driving only the first drive unit, second processing of driving only the second drive unit, and third processing of driving both of the drive units.

### TECHNICAL FIELD

The present invention relates to a door opening and closing apparatus.

### BACKGROUND ART

There is known a door opening and closing apparatus that can automatically open and close a door without a user touching a door handle. In the door opening and closing apparatus disclosed in Patent Document 1, when a user performs a predetermined movement in a detection section constituted of overlapping portions of detection ranges of a pair of distance measuring sensors, a drive unit opens and closes the door.

### PRIOR ART DOCUMENT

### Patent Document

Patent Document 1: JP 2017-82390 A

### SUMMARY OF THE INVENTION

Problems to be Solved by the Invention

Because the door opening and closing apparatus of Patent Document 1 is configured to open and close one back door disposed at a back part of a vehicle, the door opening and closing apparatus cannot be directly applied to a side part of the vehicle having two doors. That is, on the side part of the vehicle, there are cases where the user wishes to open and close only the front door, only the rear door, and both the front door and the rear door. However, the door opening and closing apparatus of Patent Document 1 is not configured in consideration of a case where there are two doors to be controlled.

An object of the present invention is to provide a door opening and closing apparatus that can reliably open and close a desired one of two doors.

### Means for Solving the Problems

According to one aspect of the present invention, there is provided a door opening and closing apparatus including: a first drive unit that opens and closes a front side door; a second drive unit that opens and closes a rear side door; a first detection section that repeatedly detects a distance to a first detection object including a moving object present in a first detection range, the first detection range being set on a side of a vehicle body; a second detection section that repeatedly detects a distance to a second detection object including the moving object present in a second detection range, the second detection range being set on the side of the vehicle body on a front side of the first detection range; and a control unit that, when the moving object is determined based on a detection result of the first detection section and a detection result of the second detection section to have performed a predetermined movement having a plurality of stages, drives at least one of the first drive unit and the second drive unit to open and close a corresponding one of the front side door and the rear side door, in which the control unit determines that, based on the detection result of the first detection section and the detection result of the second detection section, from which one of a rear, a front, and the side of the vehicle body the moving object is approaching, and according to a result of the determination, executes one of first processing of driving only the first drive unit, second processing of driving only the second drive unit, and third processing of driving both of the first drive unit and the second drive unit.

In the present aspect, when only the first detection section detects the moving object, the control unit can determine that the moving object is approaching from the rear. Further, when only the second detection section detects the moving object, the control unit can determine that the moving object is approaching from the front. Further, when both of the detection sections detect the moving object, the control unit can determine that the moving object is approaching from the side.

According to the direction from which the moving object is approaching, the control unit executes one of the first processing of opening and closing the front side door by the first drive unit, the second processing of opening and closing the rear side door by the second drive unit, and the third processing of opening and closing both of the side doors by both of the drive units. Therefore, the user who is the moving object can open and close a desired one of the two side doors by a simple movement of changing the direction from which the user is approaching.

### Effect of the Invention

In the door opening and closing apparatus of the present invention, a desired one of the two doors can be reliably opened and closed.

### BRIEF DESCRIPTION OF THE DRAWINGS

FIG. 1 is a block diagram showing a door opening and closing apparatus according to a first embodiment of the present invention;

FIG. 2A is a side view of a vehicle in which the door opening and closing apparatus is disposed;

FIG. 2B is a plan view showing a detection range of the door opening and closing apparatus;

FIG. 3A is a plan view showing a state in which a user approaches the vehicle from the rear;

FIG. 3B is a plan view showing a state in which the user approaches the vehicle from the front;

FIG. 3C is a plan view showing a state in which the user approaches the vehicle from the side;

FIG. 4 is a flowchart showing main control by a control unit;

FIG. 5 is a flowchart showing stationary object determination processing in FIG. 4;

FIG. 6 is a flowchart showing detection section setting processing in FIG. 4;

FIG. 7 is a flowchart showing distance correction processing in FIG. 4;

FIG. 8 is a flowchart showing approach determination processing in FIG. 4;

FIG. 9 is a flowchart showing authentication processing in FIG. 4;

FIG. 10 is a flowchart showing start determination processing in FIG. 4;

FIG. 11 is a flowchart showing trigger determination processing in FIG. 4;

FIG. 12 is a flowchart showing return determination processing in FIG. 4;

FIG. 13 is a flowchart showing signal output processing in FIG. 4;

FIG. 14A is a flowchart showing first processing in FIG. 13;

FIG. 14B is a flowchart showing second processing in FIG. 13; and

FIG. 14C is a flowchart showing third processing in FIG. 13.

### DESCRIPTION OF EMBODIMENTS

Hereinafter, an embodiment of the present invention is described with reference to the drawings.

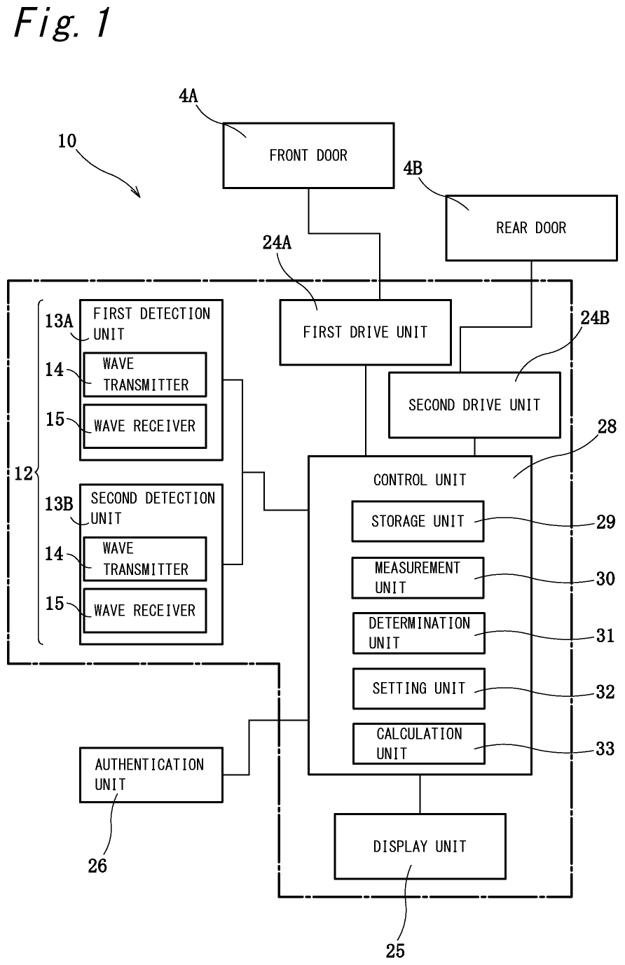

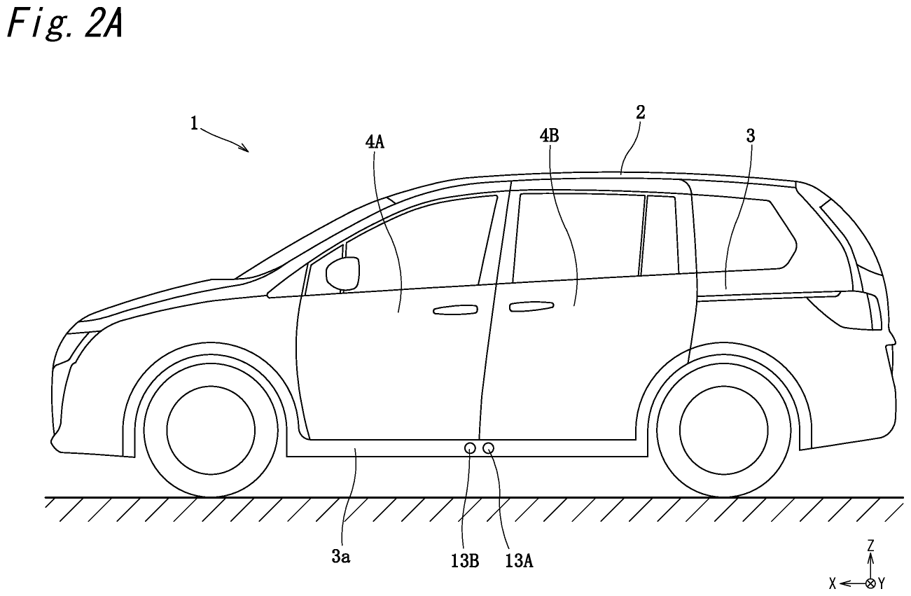

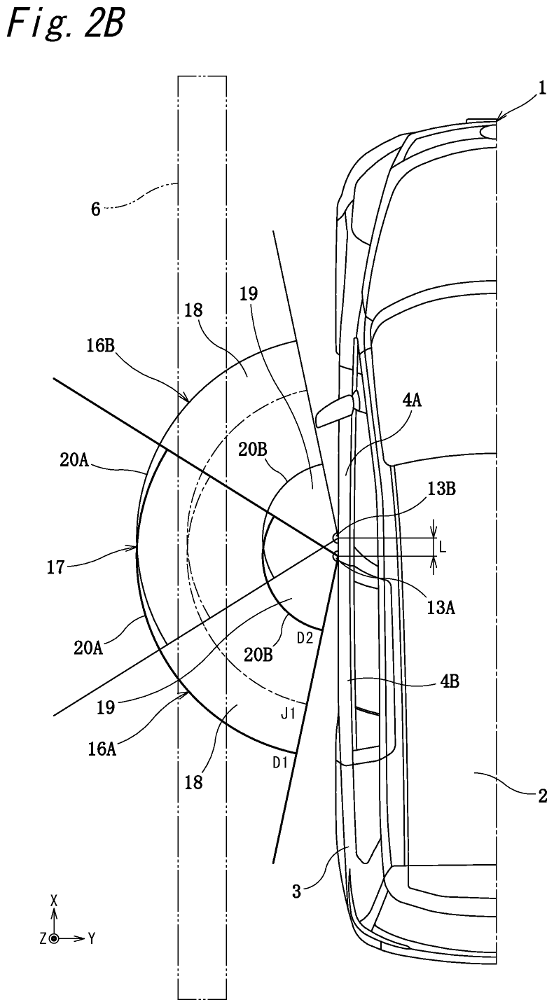

FIG. 1 shows a door opening and closing apparatus 10 for a vehicle according to an embodiment of the present invention. Referring to FIGS. 2A and 2B, the door opening and closing apparatus 10 detects a detection object present on the side of a vehicle 1, and without requiring a user to use one's hand, automatically opens and closes at least one of a front side door (hereinafter, abbreviated as a “front door”) 4A located on the front side of a side part 3 of a vehicle body 2 and a rear side door (hereinafter, abbreviated as a “rear door”) 4B located on the rear side of the side part 3. Although only a half of the vehicle 1 is illustrated in FIG. 2B, the door opening and closing apparatus 10 may be provided in the not-illustrated doors in the remaining half of the vehicle.

As shown in FIG. 1, the door opening and closing apparatus 10 includes a detection unit (detection means) 12, drive units 24A and 24B of the doors 4A and 4B, a display unit 25, an authentication unit 26, and a control unit 28. In FIG. 1, a portion surrounded by a one-dot chain line is a configuration newly added, and an existing component mounted on the vehicle 1 is used for the authentication unit 26.

Depending on the vehicle 1, other existing components may be used in addition to the authentication unit 26. For example, in the case of the vehicle 1 equipped with a side sonar sensor that monitors the side during traveling, the existing component can also be used as the detection unit 12. In addition, in the vehicle 1 equipped with a remote controller type automatic door in which the rear door 4B can be automatically opened and closed by a key (portable machine), the existing component can also be used as the drive unit 24B. In addition, in the vehicle 1 in which the front door 4A can also be automatically opened and closed by the key, the existing component can also be used as the drive unit 24A.

First, a detection object that can be detected by the detection unit 12 is described. The detection object includes a moving object that is moving and a stationary object that is not moving and is stationary. The moving object includes a user who owns the vehicle 1, a third party other than the user, and a small animal other than a human. The stationary object includes another adjacently parked vehicle and an obstacle such as a wall 6 (see FIG. 2B).

When the detection unit 12 detects the detection object, the control unit 28 determines (or performs authentication processing) by the authentication unit 26 whether or not the detection object is the user. If the authentication is not established, the control unit 28 determines that the detection object is the moving object other than the user or the stationary object, and does not open or close the doors 4A and 4B. When the authentication is established and the detection object is determined to be the user, the control unit 28 detects a predetermined movement by the user based on a change in the distance detected by the detection unit 12. At this time, the control unit 28 changes a display state by the display unit 25 to cause the user to recognize a detection state and the timing of performing the next movement. Then, when determining that the predetermined movement is established, the control unit 28 open-drives or close-drives at least one of the drive units 24A and 24B, and opens or closes the corresponding one of the doors 4A and 4B.

Specifically, there are two targets controlled by the control unit 28, which are the first drive unit 24A for the front door 4A and the second drive unit 24B for the rear door 4B. Regarding these doors, the target of the user desiring to open and close includes only the front door 4A, only the rear door 4B, and both of the front door 4A and the rear door 4B.

Therefore, in the control unit 28, first processing of opening and closing only the front door 4A, second processing of opening and closing only the rear door 4B, and third processing of opening and closing both of the front door 4A and the rear door 4B are set. In addition, in the control unit 28, a first movement for executing the first processing, a second movement for executing the second processing, and a third movement for executing the third processing are set. These predetermined movements differ only in the moving direction, and the basic walking pattern is common.

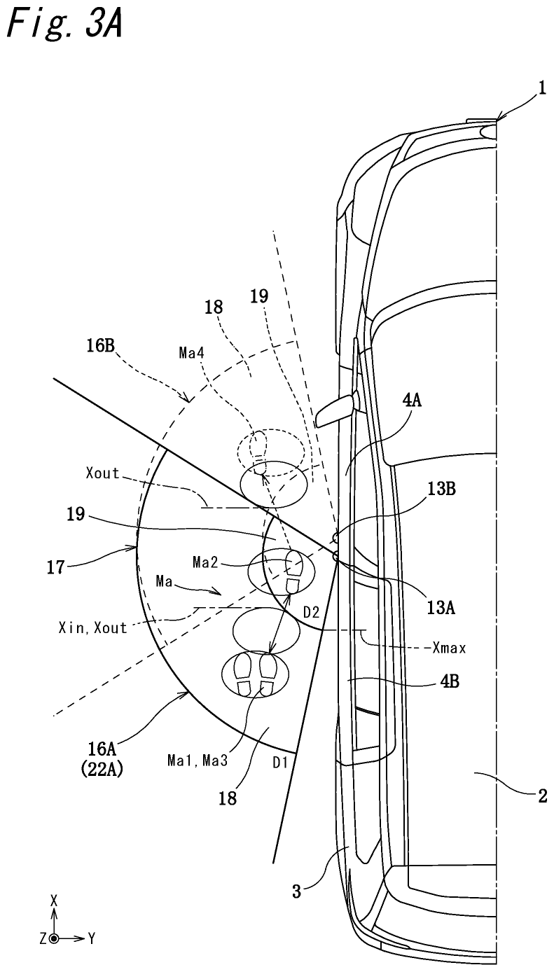

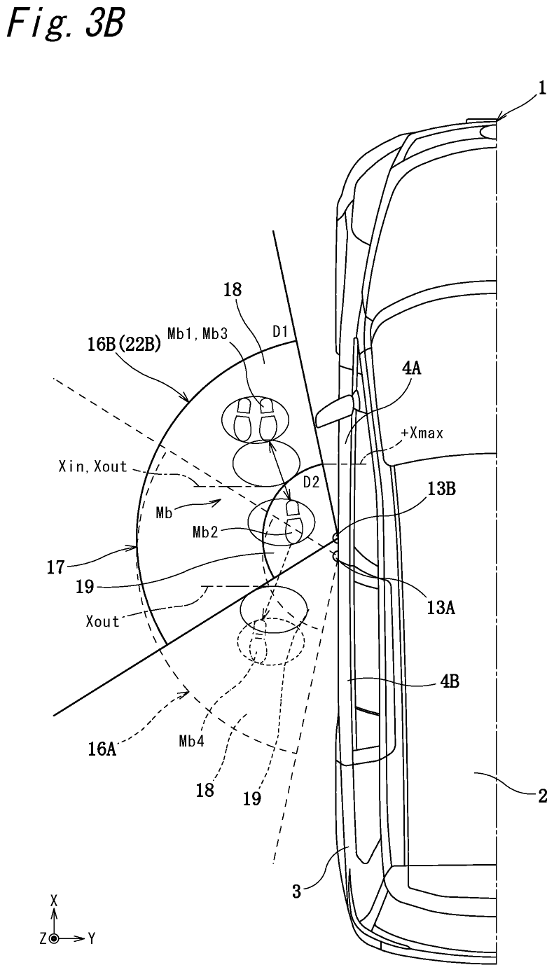

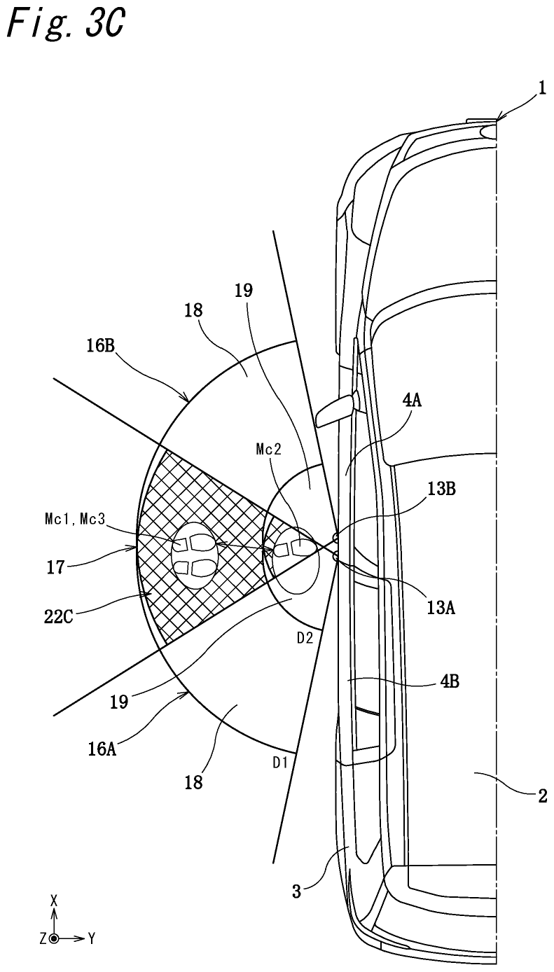

Specifically, as shown in FIG. 3A, the first movement Ma includes a series of movements (a plurality of stages) advancing and retreating from the rear toward the front along the side part 3 (from Ma1 to Ma2, then to Ma3). As shown in FIG. 3B, the second movement Mb includes a series of movements advancing and retreating from the front toward the rear along the side part 3 (from Mb1 to Mb2, then to Mb3). As shown in FIG. 3C, the third movement Mc includes a series of movements advancing and retreating toward the side part 3 in a direction intersecting the side part 3 (from Mc1 to Mc2, then to Mc3).

Hereinafter, a configuration for detecting the predetermined movements Ma to Mc by the user and opening and closing the predetermined doors 4A and 4B is specifically described.

As shown in FIGS. 2A and 2B, the detection unit 12 repeatedly detects the detection object that is present in prescribed detection ranges 16A and 16B at every set time (for example, 80 msec). The detection unit 12 includes a pair of detection sections 13A and 13B attached to the side part 3 (side step 3a) so as to be positioned at an interval in the vehicle length direction (X direction) along the doors 4A and 4B.

Referring to FIG. 1, the detection sections 13A and 13B are each communicably connected to the control unit 28 by a communication cable, and the control unit 28 is communicably connected to a not-illustrated electronic control unit (ECU). Alternatively, the detection sections 13A and 13B may be communicably connected to the ECU, and the control unit 28 may receive the detection results of the detection sections 13A and 13B from the ECU.

The detection sections 13A and 13B each include a wave transmitter 14 and a wave receiver 15. The detection ranges 16A and 16B substantially conically spread toward the side of vehicle 1 are formed by ultrasonic waves emitted from the wave transmitter 14. As shown in FIG. 2B, the detection ranges 16A and 16B each spread in a fan shape (with, for example, a center angle of about 110 degrees) on the ground. The reflected wave of the ultrasonic wave transmitted from the wave transmitter 14 is received by the wave receiver 15. This detection result is used for determining the presence of the detection object in the detection ranges 16A and 16B and calculating the distance to the detection object.

Referring to FIGS. 2A and 2B, the first detection section 13A is disposed below the rear door 4B (the rear side of the vehicle body 2), and the second detection section 13B is disposed below the front door 4A (the front side of the vehicle body 2). The first detection range 16A of the first detection section 13A extends based on the entire range on the side of the rear door 4B and toward the front door 4A side. The second detection range 16B of the second detection section 13B is located on the front side of the first detection range 16A, and extends based on the entire range on the side of the front door 4A and toward the rear door 4B side.

The detection range 16A of the detection section 13A partially overlaps with the detection range 16B of the detection section 13B. In the present embodiment, irradiation angles of the detection sections 13A and 13B are set such that the non-overlapping region of the first detection range 16A, the overlapping region of the detection ranges 16A and 16B, and the non-overlapping region of the second detection range 16B have substantially the same area in plan view. However, as long as the detection ranges 16A and 16B are disposed to include one overlapping region and a pair of non-overlapping regions respectively located in front and rear of the overlapping region, the arrangement of the detection sections 13A and 13B can be changed as necessary.

Referring to FIG. 2B, the detection ranges 16A and 16B are respectively set in regions from the detection sections 13A and 13B to a set distance D1 (for example, 120 cm). The entire region obtained by combining the detection ranges 16A and 16B is an approach region 17 used to perform authentication by the authentication unit 26 when the moving object enters the region. In order to detect the predetermined movements Ma to Mc described above in the approach region 17, the detection ranges 16A and 16B are respectively divided into a start zone 18 and a trigger zone 19 depending on the distance from the detection sections 13A and 13B.

A boundary between the start zone 18 and the trigger zone 19 is set at a position of a set distance D2 (for example, 45 cm) shorter than the set distance D1. The start zone 18 includes a region from the set distance D1 to the set distance D2, and the trigger zone 19 includes a region inside the set distance D2 and located closer to the vehicle body 2 than the start zone 18.

Referring to FIGS. 3A to 3C, the movements Ma to Mc for opening and closing the doors 4A and 4B include a first movement (first stage) moving from the start zone 18 (Ma1 to Mc1) to the trigger zone 19 (Ma2 to Mc2) and a second movement (last stage) returning from the trigger zone 19 (Ma2 to Mc2) back to the original start zone 18 (Ma3 to Mc3). That is, the predetermined movements Ma to Mc includes a plurality of (two in the present embodiment) stages. Note that returning to the original start zone 18 (Ma3 to Mc3) means moving to the first start zone 18 (Ma1 to Mc1), and does not include moving to the start zone 18 (Ma4 to Mc4) different from the first start zone 18 (Ma1 to Mc1). In addition, the predetermined movements Ma to Mc of the present embodiment have two stages, but may have three or more stages.

As shown in FIG. 1, each of the drive units 24A and 24B is communicably connected to the control unit 28 by the communication cable. However, the drive units 24A and 24B may be electrically connected to the ECU, the control unit 28 may transmit drive signals of the drive units 24A and 24B by the control unit 28 to the ECU, and the ECU may transmit the drive signals to the drive units 24A and 24B.

The drive unit 24A having received the drive signal opens and closes the front door 4A with respect to the vehicle body 2. The drive unit 24B having received the drive signal opens and closes the rear door 4B with respect to the vehicle body 2. The drive units 24A and 24B each include a motor, a gear mechanism, and a damper that can rotate the corresponding one of the doors 4A and 4B in the opening direction and the closing direction. There are various types of the doors 4A and 4B, such as a general-purpose door pivotally supported by a hinge shaft extending in the vertical direction, a gull-wing door pivotally supported by a hinge shaft extending in the horizontal direction, and a slide door moving along the side part 3. The drive units 24A and 24B only need to be configured to automatically open and close the doors 4A and 4B according to the type of the doors.

The display unit 25 includes a light-emitting diode (LED) and performs optical display for guiding the user. Although not illustrated in detail, the display unit 25 is mounted on a substrate in a casing attached to the side step 3a, and is communicably connected to the control unit 28 by a communication cable as shown in FIG. 1. The light of the display unit 25 is collected by a lens, and irradiates the ground (overlapping portion of the pair of trigger zones 19) with illuminance that allows the user to visually recognize not only when the periphery of the vehicle 1 is dark but also when the periphery of the vehicle 1 is bright.

The authentication unit 26 includes a transceiver having a vehicle external low frequency (LF) transceiver antenna that communicates with a key using an LF signal and authenticates the key outside the vehicle. The transceiver is communicably connected to the control unit 28 by a communication cable, but may be communicably connected to the ECU. The transceiver is activated in response to a command from the ECU, and performs communication related to the authentication processing. In the authentication processing, the authentication unit 26 requests the key to transmit an authentication code, compares the authentication code received from the key with a registered authorized code, and determines that a user of the key is an authorized user when the codes match with each other (or the authentication is established).

When the vehicle 1 is parked and the engine is stopped, the control unit 28 starts control for opening and closing the doors 4A and 4B. In the door opening and closing control, when the key authentication is established, the control unit 28 detects the predetermined movements Ma to Mc by the user from the change in the distance based on the detection results of the detection sections 13A and 13B, and executes the corresponding processing.

Specifically, when determining that the user is approaching from the rear of the vehicle body 2 and detecting that the user has performed the first movement Ma, the control unit 28 executes the first processing of opening and closing only the front door 4A. Further, when determining that the user is approaching from the front of the vehicle body 2 and detecting that the user has performed the second movement Mb, the control unit 28 executes the second processing of opening and closing only the rear door 4B. Further, when determining that the user is approaching from the side of the vehicle body 2 and detecting that the user has performed the third movement Mc, the control unit 28 executes the third processing of opening and closing both of the front door 4A and the rear door 4B.

More specifically, as shown in FIG. 1, the control unit 28 includes a storage unit 29, a measurement unit 30, a determination unit 31, a setting unit 32, and a calculation unit 33, is constituted of a single or a plurality of microcomputers and other electronic devices, and is communicably connected to the ECU.

The storage unit 29 stores a control program, setting data such as a threshold value and a judgment value used in the control program, a data table used for calculating a distance from the detection results of the detection sections 13A and 13B, and others. In addition, the storage unit 29 stores detection results of the detection sections 13A and 13B (distance information measured by the measurement unit 30). Furthermore, the storage unit 29 stores setting information of the detection section set by the setting unit 32 and coordinate information of the moving object calculated by the calculation unit 33.

The measurement unit 30 measures a distance from the detection sections 13A and 13B to the detection object based on a time (detection result) from when the wave transmitter 14 transmits the ultrasonic wave to when the wave receiver 15 receives the reflected wave. That is, the measurement unit 30 and the detection sections 13A and 13B constitute a distance measuring sensor that measures the distance from the detection sections 13A and 13B to the detection object. The measurement result is stored in the storage unit 29 as distance information. In the case where two or more detection objects are present at different positions in the detection ranges 16A and 16B, the number of measurement results by the detection sections 13A and 13B is the same as the number of detection objects.

The determination unit 31 individually determines whether the detection object is the moving object or the stationary object based on a change in distance in a predetermined period measured (detected) by the detection sections 13A and 13B and the measurement unit 30. That is, whether the first detection object detected by the first detection section 13A is the moving object or the stationary object is determined based on the detection result of the first detection section 13A including the measurement unit 30. In addition, whether the second detection object detected by the second detection section 13B is the moving object or the stationary object is determined based on the detection result of the second detection section 13B including the measurement unit 30.

More specifically, when the difference (amount of change) between the current detection result and the previous detection result is large, the moving distance of the detection object is long and the moving speed thereof is fast. On the other hand, when the amount of change is small, the moving distance of the detection object is short, and the moving speed thereof is slow. When moving speeds Va and Vb respectively based on the detection results of the individual detection sections 13A and 13B are less than a preset judgment value J3 (for example, 20 mm/sec), the determination unit 31 determines that the detection object is the stationary object (is stationary). When the moving speeds Va and Vb are greater than or equal to the judgment value J3, the determination unit 31 determines that the detection object is the moving object (is moving). This determination may be established only by one comparison, or may be established when the same comparison result is continuously shown a predetermined number of times (for example, 8 times=640 msec). Note that the average inclination (rate of change of the distance) of the detection results for a predetermined number of times may be calculated as the moving speeds Va and Vb.

As shown in FIGS. 3A to 3C, the setting unit 32 sets a part of the approach region 17 as a detection section for detecting the movements Ma to Mc of the user. Specifically, the setting unit 32 sets the detection section depending on whether the moving object exists in the first detection range 16A or the second detection range 16B.

As indicated by Ma1 in FIG. 3A, in the case where the first detection object detected by the first detection section 13A is the moving object and the second detection object detected by the second detection section 13B is the stationary object (wall 6 shown in FIG. 2B), the setting unit 32 sets the first detection range 16A as a detection section 22A. Further, even in the case where the first detection object detected by the first detection section 13A is the moving object and the second detection object cannot be detected by the second detection section 13B, the setting unit 32 sets the first detection range 16A as the detection section 22A. Then, when the user is determined to have performed the first movement Ma, the first processing of opening and closing only the front door 4A is executed.

As indicated by Mb1 in FIG. 3B, in the case where the first detection object detected by the first detection section 13A is the stationary object and the second detection object detected by the second detection section 13B is the moving object, the setting unit 32 sets the second detection range 16B as a detection section 22B. Further, even in the case where the first detection object cannot be detected by the first detection section 13A and the second detection object detected by the second detection section 13B is the moving object, the setting unit 32 sets the second detection range 16B as the detection section 22B. Then, when the user is determined to have performed the second movement Mb, the second processing of opening and closing only the rear door 4B is executed.

As indicated by Mc1 in FIG. 3C, in the case where the detection object detected by both of the detection sections 13A and 13B is the moving object, the setting unit 32 sets the overlapping portion of the adjacent detection ranges 16A and 16B, more specifically, the overlapping portion of the two start zones 18 and the overlapping portion of the two trigger zones 19 as a detection section 22C. Then, when the user is determined to have performed the third movement Mc, the third processing of opening and closing both of the front door 4A and the rear door 4B is executed.

The setting of each of the detection sections 22A to 22C may be established only by one determination, or may be established when the same determination result is continuously shown a predetermined number of times (for example, 4 time =320 msec). When neither of the detection sections 13A and 13B can detect the detection object, the detection sections 22A to 22C are not set.

The calculation unit 33 calculates a coordinate (X coordinate which is the vehicle length direction) of the moving object based on the distance detected by the first detection section 13A and the distance detected by the second detection section 13B. Here, as described above, a plurality of signals is input to the wave receiver 15 according to the number of detection objects that is present in the detection ranges 16A and 16B. The calculation unit 33 calculates the X coordinate by using the signal (distances Da and Db to the moving object) returned earliest among the plurality of signals. The X coordinate is calculated by the following equation with the center between the detection sections 13A and 13B as the origin.

X=(Da2−Db2+L2)/2L−L/2=(Da2−Db2)/2L [Mathematical Equation 1]
Da: Distance detected by the first detection section
Db: Distance detected by the second detection section
L: Interval between the first detection section and the second detection section

However, as shown in FIG. 3A, in the case of setting the first detection range 16A to the current detection section 22A and the second detection section 13B does not detect the moving object, the X coordinate is set to −Xmax. Further, as shown in FIG. 3B, in the case of setting the second detection range 16B to the current detection section 22B and the first detection section 13A does not detect the moving object, the X coordinate is set to +Xmax. Note that −Xmax means a position farthest from the second detection range 16B in the trigger zone 19 of the first detection range 16A. +Xmax means a position farthest from the first detection range 16A in the trigger zone 19 of the second detection range 16B.

For example, in the case where the moving object is present in a portion of the first detection range 16A where the second detection range 16B does not overlap therewith, Xin is set by the moving object moving from the start zone 18 to the trigger zone 19 in the first detection range 16A. However, when the second detection section 13B cannot detect the moving object, the X coordinate cannot be calculated. Therefore, in this case, the X coordinate is set to −Xmax or +Xmax, which is a fixed value, according to the current setting of the detection sections 22A and 22B.

In the case where one of the first detection object detected by the first detection section 13A and the second detection object detected by the second detection section 13B is the moving object and the other is the stationary object, and the distance to the stationary object is shorter than a judgment value J1 (see FIG. 2B), the detection result used to detect the predetermined movements Ma and Mb differs depending on the stage. Specifically, for the detection of the first movement (first stage) from the start zone 18 to the trigger zone 19, only the detection result (distance Da or Db) of the one of the two detection sections 13A and 13B that has detected the moving object is used. In addition, for the detection of the second movement (last stage) from the trigger zone 19 to the start zone 18, both of the detection results (distances Da and Db) of the two detection sections 13A and 13B are used. Note that the judgment value J1 is a distance shorter than the set distance D1 and longer than the set distance D2 with respect to the detection sections 13A and 13B (for example, 90 cm).

As shown in FIG. 3A, in the case where the first detection object detected by the first detection section 13A is the moving object and the second detection object detected by the second detection section 13B is the stationary object, the control unit 28 only uses the distance Da detected by the first detection section 13A to detect the first movement by the moving object. As shown in FIG. 3B, in the case where the first detection object detected by the first detection section 13A is the stationary object and the second detection object detected by the second detection section 13B is the moving object, the control unit 28 only uses the distance Db detected by the second detection section 13B to detect the first movement by the moving object. In either case, the control unit 28 uses both of the distances Da and Db detected by the detection sections 13A and 13B to detect the second movement by the moving object.

As shown in FIG. 3C, in the case where both of the first detection object detected by the first detection section 13A and the second detection object detected by the second detection section 13B are moving objects, the control unit 28 uses both of the distances Da and Db detected by the detection sections 13A and 13B to determine a series of movements constituting the predetermined movement Mc.

As shown in FIG. 2B, in the case where the wall 6 is present around the doors 4A and 4B, only one of the distances Da and Db of the detection sections 13A and 13B is used for the detection of the first movement by the user (moving object), but both of the distances Da and Db detected by the detection sections 13A and 13B are always used for the detection of the detection object including the stationary object. Then, the control unit 28 replaces the distance Db or Da detected by the detection section 13B or 13A that has detected the stationary object so as to have the same value as the distance Da or Db detected by the detection section 13A or 13B that has detected the moving object. That is, in the case where only the distance Da of the first detection section 13A is used for detecting the moving object, the control unit 28 replaces the distance Db detected by the second detection section 13B with the same value as the distance Da detected by the first detection section 13A. Further, in the case where only the distance Db of the second detection section 13B is used for detecting the moving object, the control unit 28 replaces the distance Da detected by the first detection section 13A with the same value as the distance Db detected by the second detection section 13B.

In the case where there is no wall 6 around the doors 4A and 4B, both of the distances Da and Db detected by the detection sections 13A and 13B are used for detecting the moving object. On the other hand, in the case where the wall 6 is present, an actual measurement value is used for one of the individual distances detected by the detection sections 13A and 13B, and a correction value is used for the other of the distances. That is, regardless of the presence of the wall 6, because the two distances Da and Db are used for the opening and closing control of the doors 4A and 4B, the same program can be used.

In the case where the wall 6 is present around the doors 4A and 4B, only one of the distances Da and Db of the detection sections 13A and 13B is used for the detection of the first movement, but the distances Da and Db detected by both of the detection sections 13A and 13B are used for the detection of the second movement (determination whether or not the predetermined movement Ma is established). Needless to say, even in the case where the wall 6 is not present, the distances Da and Db detected by both of the detection sections 13A and 13B are used to determine whether or not the predetermined movement Mb is established.

Specifically, the control unit 28 determines whether or not the predetermined movements Ma to Mc are established based on the amount of change of the X coordinate calculated by the calculation unit 33. More specifically, the control unit 28 compares the absolute value with a second judgment value J2 (for example, 30 cm), the absolute value being the difference between a first coordinate (that is, the coordinate of Ma2 to Mc2) at the time of performing the first movement of advancing from the start zone 18 to the trigger zone 19 and a second coordinate at the time of retreating from the trigger zone 19.

When the absolute value of the difference between the first coordinate Xin and the second coordinate Xout is smaller than the judgment value J2, that is, when the second movement of retreating from the trigger zone 19 to the start zone 18 is performed (that is, the coordinate of Ma3 to Mc3), the control unit 28 determines that the predetermined movements Ma to Mc are established. Further, when the absolute value of the difference between the first coordinate Xin and the second coordinate Xout is equal to or more than the judgment value J2, that is, when the movement of advancing from the trigger zone 19 to the start zone 18 of the adjacent detection range 16A or 16B is performed (that is, the coordinate of Ma4 to Mc4), the control unit 28 determines that the predetermined movements Ma to Mc are not established.

As shown in FIGS. 3A to 3C, the movement of the user when passing by the vehicle 1 is from Ma1 to Ma2 and to Ma4, or from Mb1 to Mb2 and to Mb4, or from Mc1 to Mc2 and to Mc4. On the other hand, the predetermined movement is from Ma1 to Ma2 and to Ma3, or from Mb1 to Mb2 and to Mb3, or from Mc1 to Mc2 and to Mc3. Therefore, by comparing the absolute value with the judgment value J2, the absolute value being the difference between the first coordinate Xin (coordinate of Ma2, Mb2, and Mc2) at the time of performing the first movement and the subsequent second coordinate Xout (coordinate of Ma3, Mb3, and Mc3 or Ma4, Mb4, and Mc4), the determination of whether or not the user is passing by can be determined. Therefore, an erroneous operation of the door opening and closing apparatus 10 caused by the user passing by can be prevented.

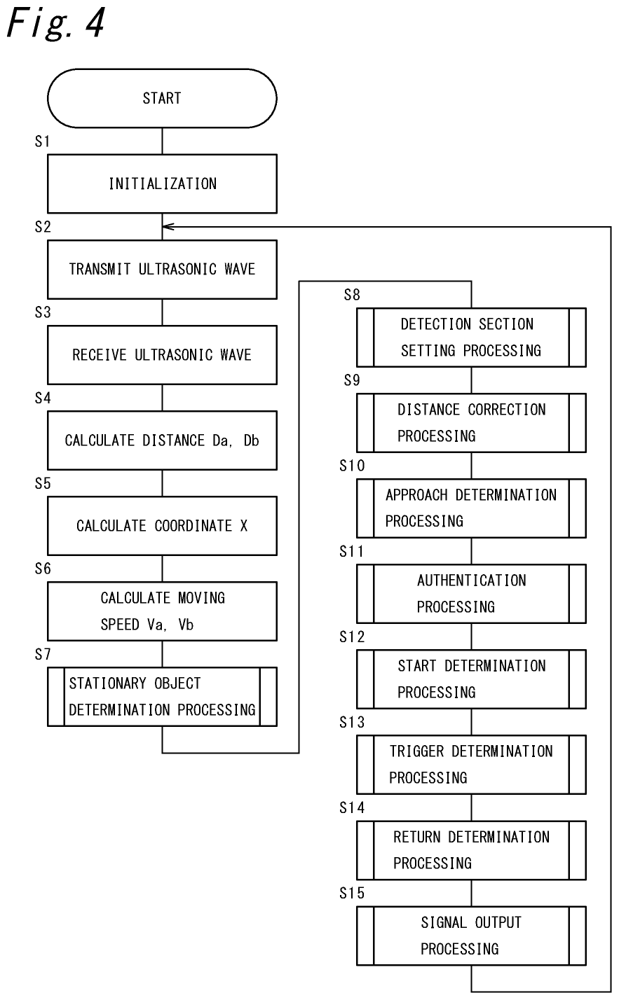

Next, door opening and closing control by the control unit 28 is described with reference to flowcharts shown in FIGS. 4 to 13.

### Main Flow

The door opening and closing control by the control unit 28 is started when the vehicle 1 is parked and the engine is stopped. As shown in FIG. 4, in the door opening and closing control, the control unit 28 detects the movements Ma to Mc of the user (steps S6 to S13), and repeatedly detects the detection object by the detection sections 13A and 13B (steps S2 to S5) until the determination of whether or not the predetermined movements Ma to Mc are established is confirmed (step S14). Then, only when the predetermined movements Ma to Mc are established, at least one of the doors 4A and 4B is opened and closed (step S15).

Specifically, the control unit 28 initializes the storage unit 29 in step S1, and erases information obtained by the previous door opening and closing control. Subsequently, in step S2, ultrasonic waves are transmitted from the wave transmitters 14 of the detection sections 13A and 13B, and in step S3, reflected ultrasonic waves are received by the wave receivers 15 of the detection sections 13A and 13B. Specifically, the first detection section 13A transmits and receives the ultrasonic wave, and after a certain standby time provided for completely eliminating reverberation of the first detection section 13A, the second detection section 13B transmits and receives the ultrasonic wave. This is to prevent erroneous detection between the detection sections 13A and 13B.

Subsequently, in step S4, the distances Da and Db from the individual detection sections 13A and 13B to the detection object are calculated based on the detection results (time from transmission to reception) of detection sections 13A and 13B. At this time, the same number of detection results according to the number of detection objects are input to the control unit 28, and the measurement unit 30 calculates the distances Da and Db to the detection object using the detection result that has been received earliest among the detection results.

Subsequently, in step S5, the calculation unit 33 calculates the X coordinate of the detection object using the distances Da and Db, and then in step S6, by using the current distances Da and Db and the previous distances Da and Db stored in the storage unit 29, the moving speeds Va and Vb of the detection object are calculated from the amount of change in the distances. Thereafter, in step S7, stationary object determination processing is executed using the absolute values of the calculated moving speeds Va and Vb, subsequently, in step S8, detection section setting processing is executed using the determination results of the moving object and the stationary object, and then in step S9, correction processing of the calculated distances Da and Db is executed.

Subsequently, in step S10, approach determination processing of detecting the moving object in the approach region 17 is executed, and thereafter, in step S11, authentication processing of determining whether or not the detection object is the user is executed. Thereafter, in step S12, in order to detect the movements Ma to Mc of the user, start determination processing is executed, in step S13, trigger determination processing is executed, and then in step S14, return determination processing is executed. Then, in step S15, when the predetermined movements Ma to Mc are established, signal output processing for driving the doors 4A and 4b to open or close is executed.

### Step S7: Stationary Object Determination Processing

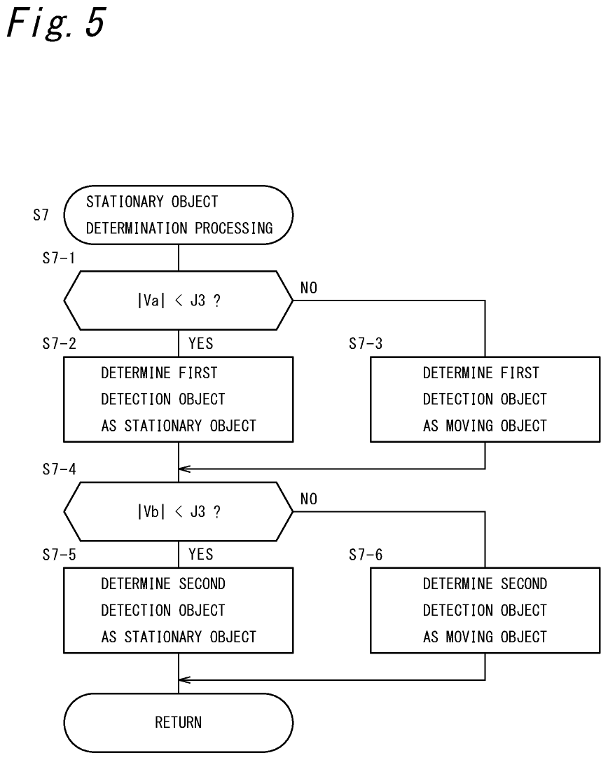

As shown in FIG. 5, in the stationary object determination processing, the absolute values of the moving speeds Va and Vb of the detection object calculated in step S6 are compared with the judgment value J3, and it is determined whether the detection object that is detected is the moving object or the stationary object. Then, the detection object that is determined to be the stationary object is stored in the storage unit 29 together with the distance information.

Specifically, in step S7-1, the determination unit 31 compares the absolute value of the moving speed Va obtained from the detection result of the first detection section 13A with the judgment value J3. When the absolute value of the moving speed Va is less than the judgment value J3, it is determined in step S7-2 that the first detection object is the stationary object, and when the absolute value of the moving speed Va is equal to or more than the judgment value J3, it is determined in step S7-3 that the first detection object is the moving object.

Subsequently, in step S7-4, the determination unit 31 compares the absolute value of the moving speed Vb obtained from the detection result of the second detection section 13B with the judgment value J3. When the absolute value of the moving speed Vb is less than the judgment value J3, it is determined in step S7-5 that the second detection object is the stationary object, and when the absolute value of the moving speed Vb is equal to or more than the judgment value J3, it is determined in step S7-6 that the second detection object is the moving object.

### Step S8: Detection Section Setting Processing

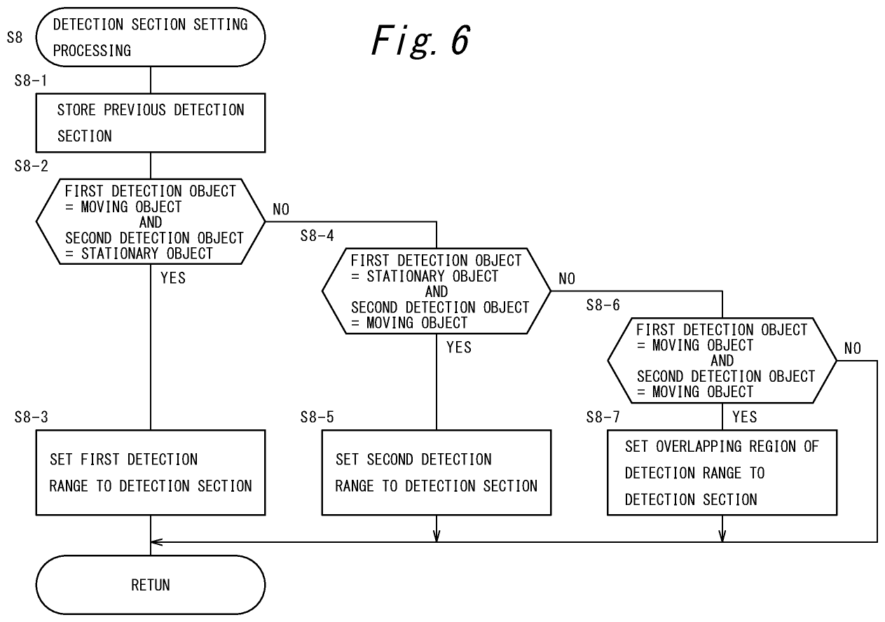

As shown in FIG. 6, in the detection section setting processing, one of the detection sections 22A to 22C is set based on the determination result of whether the detection object is the moving object or the stationary object by the determination unit 31.

Specifically, in step S8-1, the control unit 28 stores the previously set detection sections 22A to 22C in the storage unit 29.

Subsequently, in step S8-2, it is determined whether the first detection object detected by the first detection section 13A is the moving object and the second detection object detected by the second detection section 13B is the stationary object. If this condition is satisfied, in step S8-3, the first detection range 16A is set to the detection section 22A.

If the condition is not satisfied in step S8-2, the control unit 28 determines in step S8-4 whether the first detection object detected by the first detection section 13A is the stationary object and the second detection object detected by the second detection section 13B is the moving object. If this condition is satisfied, in step S8-5, the second detection range 16B is set to the detection section 22B.

If the condition is not satisfied in step S8-4, the control unit 28 determines in step S8-6 whether the first detection object detected by the first detection section 13A is the moving object and the second detection object detected by the second detection section 13B is also the moving object. If this condition is satisfied, in step S8-7, the overlapping portion of the two detection ranges 16A and 16B are set to the detection section 22C.

If the condition is not satisfied in step S8-6, which means that the first detection object detected by the first detection section 13A is the stationary object and the second detection object detected by the second detection section 13B is also the stationary object, the control unit 28 does not change the setting of the detection sections 22A to 22C. As a result, the previous setting is maintained. However, the setting may be set to “no setting” which means none of the detection sections 22 A to 22 C is set.

### Step S9: Distance Correction Processing

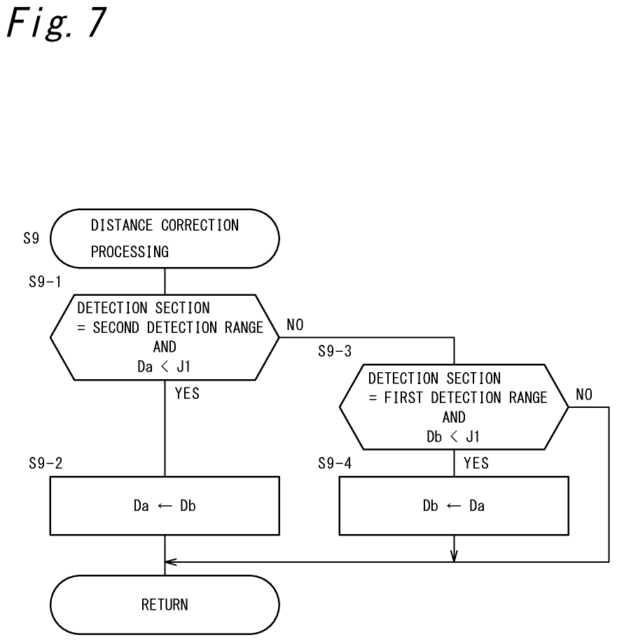

As shown in FIG. 7, in the distance correction processing, in the case where the wall 6 is present around the doors 4A and 4B, the control unit 28 replaces the detection result (distance Da or Db) of the detection section 13A or 13B that has detected the wall 6 with the same value as the detection result (distance Db or Da) of the detection section 13B or 13A that has detected the moving object. As a result, the detected distance to the wall 6 is not used for detecting the moving object.

Specifically, in step S9-1, the control unit 28 determines whether or not the second detection range 16B is set as the detection section 22B and the distance Da detected by the first detection section 13A is less than the judgment value J1. Then, if this condition is satisfied, in step S9-2, the distance Da detected by the first detection section 13A is replaced with the same value as the distance Db detected by the second detection section 13B.

If the condition is not satisfied in step S9-1, in step S9-3, the control unit 28 determines whether or not the first detection range 16A is set as the detection section 22A and the distance Db detected by the second detection section 13B is less than the judgment value J1. Then, if this condition is satisfied, in step S9-4, the distance Db detected by the second detection section 13B is replaced with the same value as the distance Da detected by the first detection section 13A.

If the condition is not satisfied in step S9-3, that is, when there is no wall 6 around the doors 4A and 4B, or when the detection objects detected by the detection sections 13A and 13B are both moving objects, the control unit 28 does not correct (replace) either the distance Da detected by the first detection section 13A or the distance Db detected by the second detection section 13B.

### Step S10: Approach Determination Processing

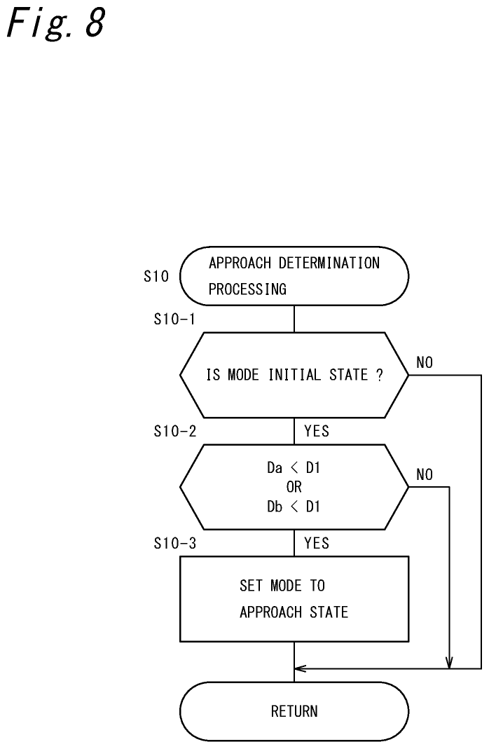

As shown in FIG. 8, in the approach determination processing, the control unit 28 detects whether or not the moving object including the user and the third party is present in the approach region 17.

Specifically, in step S10-1, the control unit 28 determines whether or not the mode of the door opening and closing control is in an initial state. When the mode is in the initial state, it is determined in step S10-2 whether or not the distance Da to the moving object detected by the first detection section 13A or the distance Db to the moving object detected by the second detection section 13B is less than the set distance D1. When the distance Da or Db is less than the set distance D1, in step S10-3, the mode of the door opening and closing control is set to an approach state and the process returns.

On the other hand, when the mode of the door opening and closing control is not the initial state in step S10-1 and when both of the distances Da and Db are equal to or more than the set distance D1 in step S10-2, the control unit 28 returns the process without changing the mode of the door opening and closing control.

### Step S11: Authentication Processing

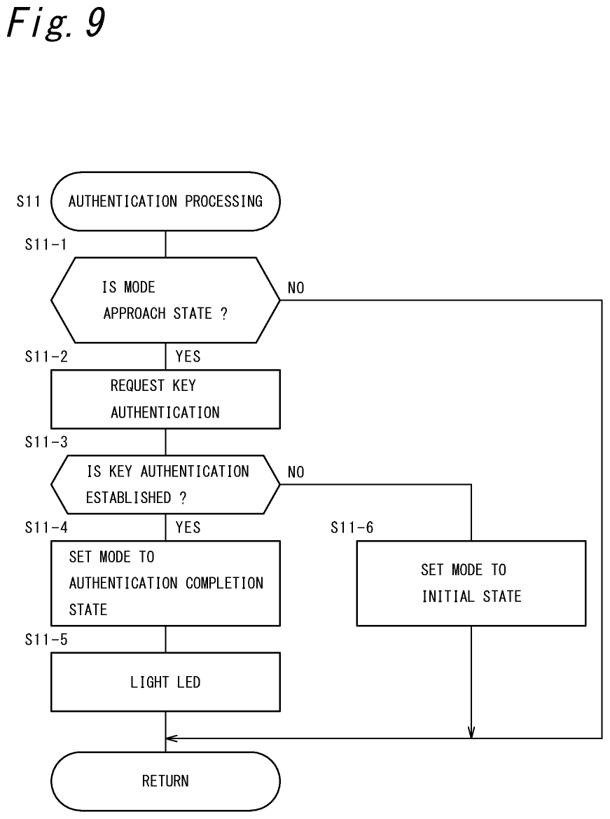

As shown in FIG. 9, in the authentication processing, it is determined whether the moving object present in the approach region 17 is the user or the third party other than the user. When the moving object is determined to be the user, the mode is shifted to a mode for detecting the predetermined movements Ma to Mc, and when the moving object is determined to be other than the user, the mode is returned to the initial state.

Specifically, in step S11-1, the control unit 28 determines whether or not the mode of the door opening and closing control is in the approach state. When the mode is in the approach state, in step S11-2, the key authentication is requested to the authentication unit 26. Thereafter, in step S11-3, if the key authentication is determined to be established (the code is matched), in step S11-4, the mode of the door opening and closing control is set to an authentication completion state, and in step S11-5, the display unit 25 is switched from a lighting-off state to a lighting state, and the process returns.

On the other hand, when the mode of the door opening and closing control is not in the approach state in step S11-1, the control unit 28 returns the process without performing the subsequent steps. In addition, if the key authentication is not established (the codes do not match) in step S11-3, in step S11-6, the mode of the door opening and closing control is set to the initial state and the process returns.

### Step S12: Start Determination Processing

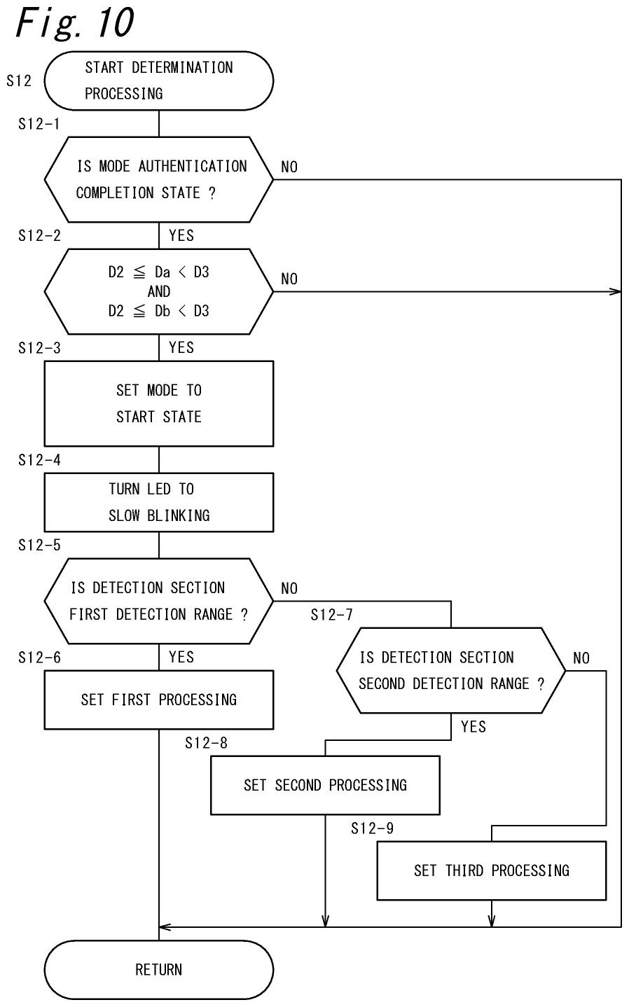

As shown in FIG. 10, in the start determination processing, the process waits until the user moves to the start zone 18 of the detection sections 22A to 22C set by the setting unit 32 in step S8 (see FIGS. 4 and 6), and it is set that which one of the first processing to the third processing is to be executed.

Specifically, in step S12-1, the control unit 28 determines whether or not the mode of the door opening and closing control is in the authentication completion state. When the mode is in the authentication completion state, it is determined in step S12-2 whether or not both of the distances Da and Db to the user detected by the detection sections 13A and 13B is equal to more than the set distance D2 and less than a set distance D3 (for example, 100 cm). If this condition is satisfied, that is, when the user has moved to the start zone 18, in step S12-3, the mode of the door opening and closing control is set to the start state, and in step S12-4, the display unit 25 is switched from the lighting state to a slow blinking state.

On the other hand, when the mode of the door opening and closing control is not in the authentication completion state in step S12-1 and the condition is not satisfied in step S12-2, the control unit 28 returns the process without performing the subsequent steps. Note that when the user is located in a place other than the start zone 18 in the predetermined detection sections 22A to 22C, the condition of step S12-2 is not satisfied.

Here, in the case where the overlapping portions of the detection ranges 16A and 16B are set to the detection section 22C as shown in FIG. 3C, when the user moves to the start zone 18 (Mc1), the actual detection results (distances Da and Db) of the detection sections 13A and 13B both satisfy the condition of step S12-2. On the other hand, in the case where the first detection range 16A is set to the detection section 22A as shown in FIG. 3A, even when the user moves to the start zone 18 (Ma1), the actual detection result (distance Db) of the second detection section 13B does not satisfy the condition of step S12-2. Further, in the case where the second detection range 16B is set to the detection section 22B as shown in FIG. 3B, even when the user moves to the start zone 18 (Mb1), the actual detection result (distance Da) of the first detection section 13A does not satisfy the condition of step S12-2. However, in the present embodiment, in the case of FIGS. 3A and 3B, because the detection results (distances Db and Da) are corrected by the distance correction processing of step S9 (see FIGS. 4 and 7), both of the detection results (distances Da and Db) of the detection sections 13A and 13B after the correction satisfy the condition of step S12-2.

After the lighting state of the display unit 25 is switched in step S12-4, in the following step S12-5, it is detected (checked) whether the detection section is set in the first detection range 16A. Then, in the case where the detection section is set in the first detection range 16A, in step S12-6, the first processing in which only the front door 4A is driven to open and close is executed, and the process returns. That is, if it is determined in step S8-2 (see FIG. 6) that the first detection object detected by the first detection section 13A is the moving object and the second detection object detected by the second detection section 13B is the stationary object, the control unit 28 determines to execute the first processing. In other words, in the first stage of the predetermined movements Ma to Mc, if it is determined that the user (moving object) is present only in the start zone 18 of the first detection range 16A, the control unit 28 determines to execute the first processing.

If the detection section is not set in the first detection range 16A in step S12-5, in step S12-7, it is detected (checked) whether the detection section is set in the second detection range 16B. Then, in the case where the detection section is set in the second detection range 16B, in step S12-8, the second processing in which only the rear door 4B is driven to open and close is executed, and the process returns. That is, if it is determined in step S8-4 (see FIG. 6) that the first detection object detected by the first detection section 13A is the stationary object and the second detection object detected by the second detection section 13B is the moving object, the control unit 28 determines to execute the second processing. In other words, in the first stage of the predetermined movements Ma to Mc, if it is determined that the user is present only in the start zone 18 of the second detection range 16B, the control unit 28 determines to execute the second processing.

On the other hand, in the case where the detection section is not set in the second detection range 16B in step S12-7, that is, in the case where the detection section is set in the overlapping region of the detection ranges 16A and 16B, it is set in step S12-9 to execute the third processing in which both of the doors 4A and 4B are driven to be opened and closed, and the process returns. That is, if it is determined in step S8-6 (see FIG. 6) that the detection object detected by both of the detection sections 13A and 13B is the moving object, the control unit 28 determines to execute the third processing. In other words, in the first stage of the predetermined movements Ma to Mc, if it is determined that the user is present in the start zones 18 of the respective detection ranges 16A and 16B, the control unit 28 determines to execute the third processing.

### Step S13: Trigger Determination Processing

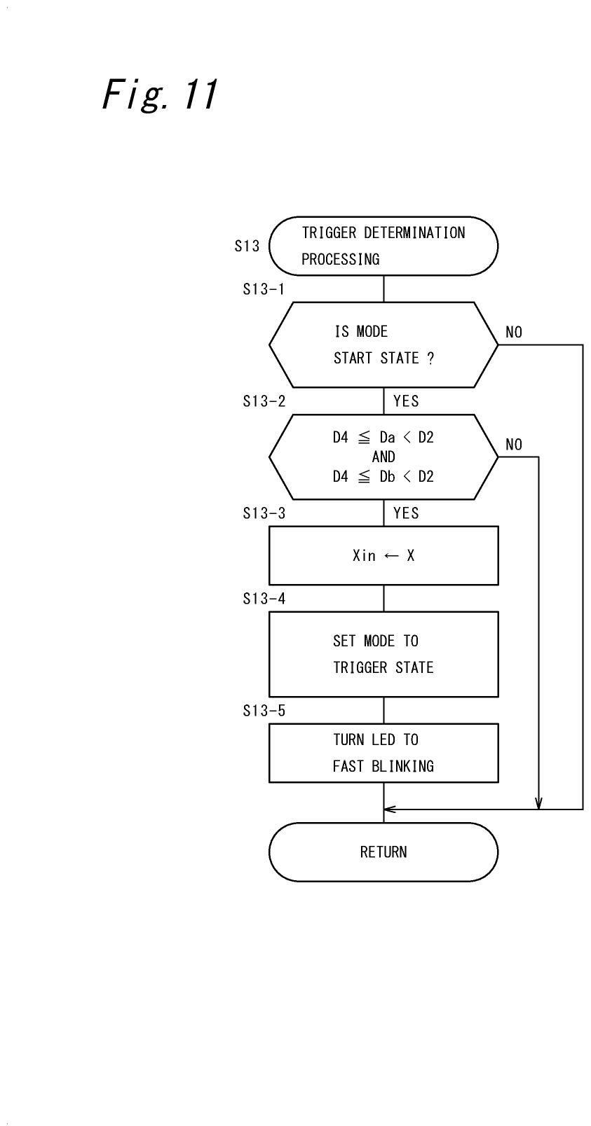

As shown in FIG. 11, in the trigger determination processing, the process waits until the first movement is detected, that is, until the user moves to the trigger zone 19 of the detection sections 22A to 22C set by the setting unit 32.

Specifically, in step S13-1, the control unit 28 determines whether or not the mode of the door opening and closing control is in the start state. When the mode is in the start state, it is determined in step S13-2 whether or not both of the distances Da and Db to the user detected by the detection sections 13A and 13B is equal to more than a set distance D4 (for example, 25 cm) and less than the set distance D2. If this condition is satisfied, that is, when the user has moved to the trigger zone 19, in step S13-3, the X coordinate calculated in step S5 (see FIG. 4) is stored in the storage unit 29 as the first coordinate Xin. Thereafter, in step S13-4, the mode of the door opening and closing control is set to a trigger state, and in step S13-5, the display unit 25 is switched from the slow blinking state to a fast blinking state, and the process returns.

On the other hand, when the mode of the door opening and closing control is not in the start state in step S13-1 and the condition is not satisfied in step S13-2, the control unit 28 returns the process without performing the subsequent steps. Note that when the user is located in a place other than the trigger zone 19 in the predetermined detection sections 22A to 22C, the condition of step S13-2 is not satisfied.

Similarly to the start determination processing described above, in the case where the overlapping portions of the detection ranges 16A and 16B are set to the detection section 22C as shown in FIG. 3C, when the user moves to the trigger zone 19 (Mc2), the actual detection results (distances Da and Db) of the detection sections 13A and 13B both satisfy the condition of step S13-2. On the other hand, in the case where the first detection range 16A is set as the detection section 22A as shown in FIG. 3A, or in the case where the second detection range 16B is set as the detection section 22B as shown in FIG. 3B, even when the user moves to the trigger zone 19 (Ma2 and Mb2), the actual detection results of the detection sections 13A and 13B do not satisfy the condition of step S13-2. However, in the present embodiment, because the detection results (distances Db and Da) are corrected by the distance correction processing of step S9, both of the detection results (distances Da and Db) of the detection sections 13A and 13B after the correction satisfy the condition of step S13-2.

### Step S14: Return Determination Processing

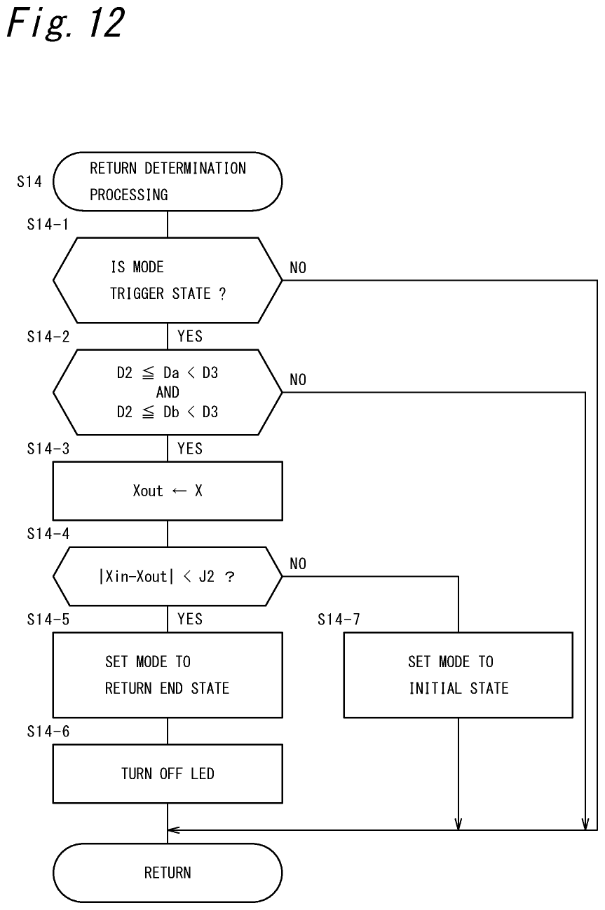

As shown in FIG. 12, in the return determination processing, the process waits until the second movement is detected, that is, until the user retreats from the trigger zone 19, and it is determined whether or not the predetermined movements Ma to Mc are established, based on the position of the user at the time of having retreated from the trigger zone 19.

Specifically, in step S14-1, the control unit 28 determines whether or not the mode of the door opening and closing control is in the trigger state. When the mode is in the trigger state, it is determined in step S14-2 whether or not both of the distances Da and Db to the user detected by the detection sections 13A and 13B are equal to more than the set distance D2 and less than the set distance D3 (for example, 100 cm). If this condition is satisfied, that is, when the user has retreated from the trigger zone 19, in step S14-3, the X coordinate calculated in step S5 (see FIG. 4) is stored in the storage unit 29 as the second coordinate Xout.

Subsequently, in step S14-4, it is determined whether or not the absolute value of the distance obtained by subtracting the second coordinate Xout from the first coordinate Xin is less than the judgment value J2 (for example, 30 cm). If this condition is satisfied, that is, when the user has moved to the start zone 18, in step S14-5, the mode of the door opening and closing control is set to a return end state, and in step S14-6, the display unit 25 is switched from the fast blinking state to the lighting-off state. In addition, if the condition is not satisfied in step S14-4, in step S14-7, the mode of the door opening and closing control is set to the initial state and the process returns.

On the other hand, when the mode of the door opening and closing control is not in the trigger state in step S14-1, and if the condition is not satisfied in the step S14-2, the control unit 28 returns the process without performing the subsequent steps. Note that the condition of step S14-2 is not satisfied until the user retreats from the trigger zone 19 in the predetermined detection sections 22A to 22C.

Here, in the case where the overlapping portions of the detection ranges 16A and 16B are set as the detection section 22C as shown in FIG. 3C, when the user moves to the start zone 18 (Mc3), the actual detection results (distances Da and Db) of the detection sections 13A and 13B both satisfy the condition of step S14-2. In addition, when there is no wall 6 around the doors 4A and 4B, because the predetermined movement Mc is a series of movements of advancing and retreating in a direction orthogonal to the doors 4A and 4B, there is almost no movement in the vehicle width direction by the user. Therefore, the actual detection results (distances Da and Db) of the detection sections 13A and 13B both satisfy the condition of step S14-4.

On the other hand, in the case where the first detection range 16A is set to the detection section 22A as shown in FIG. 3A, or in the case where the second detection range 16B is set to the detection section 22B as shown in FIG. 3B, even when the user moves to the start zone 18 (Ma3 and Mb3), the actual detection results (distances Da and Db) of the detection sections 13A and 13B do not satisfy the condition of step S14-2. However, in the present embodiment, because the detection results (distances Db and Da) are corrected by the distance correction processing of step S9 (see FIGS. 4 and 7), the detection results of the detection sections 13A and 13B after the correction both satisfy the condition of step S14-2.

In addition, when the wall 6 is present around the doors 4A and 4B (see FIG. 2B), the predetermined movements Ma and Mb are a series of movements to advance and retreat along the doors 4A and 4B. After the user has moved from the start zone 18 to the trigger zone 19 (Ma2 and Mb2), the amount of movement when the user returns to the start zone 18 (Ma3 and Mb3) is smaller than the amount of movement when the user passes by (Ma4 and Mb4). Therefore, in the former case, the actual detection results (distances Da and Db) of the detection sections 13A and 13B after the correction both satisfy the condition of step S14-4. On the other hand, in the latter case, the actual detection results (distances Da and Db) of the detection sections 13A and 13B after the correction do not satisfy the condition of step S14-4. As shown in FIG. 3C, even in the case when the user passes by the vehicle 1 from the side to the front and the rear (Mc4), the condition in step S14-4 is not satisfied. Therefore, the movement of returning to the start zone 18 of the predetermined detection sections 22 A to 22 C can be clearly distinguished from the movement of passing by.

### Step S15: Signal Output Processing

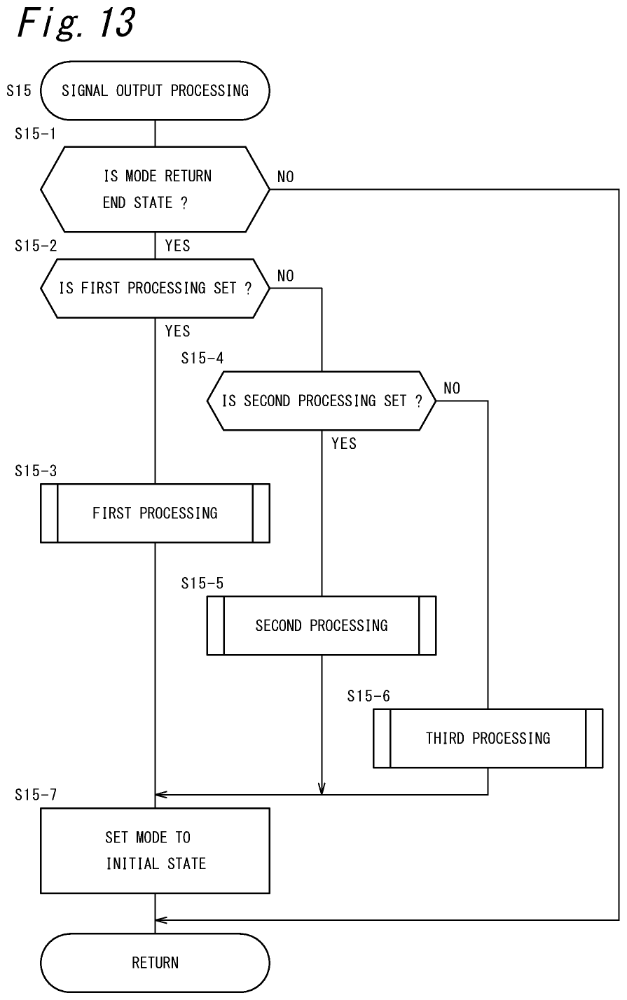

As shown in FIG. 13, in the signal output processing, at least one of the drive units 24A and 24B is driven according to which one of the first processing to the third processing is set, and the corresponding doors 4A and 4B are opened and closed.

Specifically, in step S15-1, the control unit 28 determines whether or not the mode of the door opening and closing control is in the return end state. When the mode is not in the return end state, the process returns without performing the subsequent steps.

When the mode is in the return end state in step S15-1, it is detected (confirmed) whether or not the mode is set to the first processing in step S15-2. Then, when the mode is the first processing, the first processing is executed in step S15-3. When the mode is not the first processing, it is detected in step S15-4 whether or not the mode is set to the second processing. Then, when the mode is the second processing, the second processing is executed in step S15-5, and when the mode is not the second processing, the third processing is executed in step S15-6.

When any one of the first processing to the third processing is completed, the mode of the door opening and closing control is set to the initial state in step S15-7, and the process returns.

### Step S15-3: First Processing

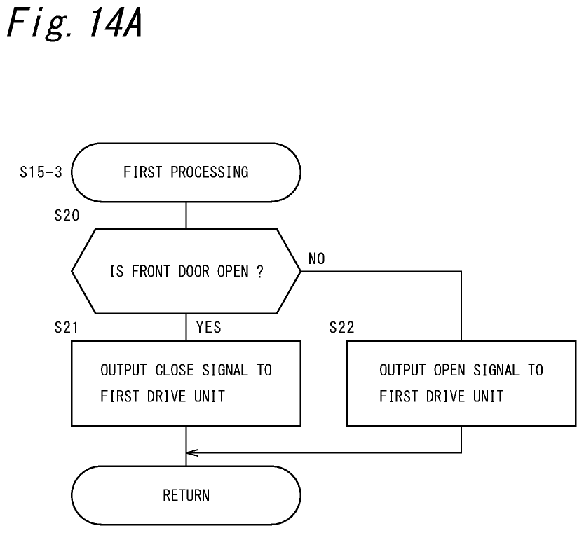

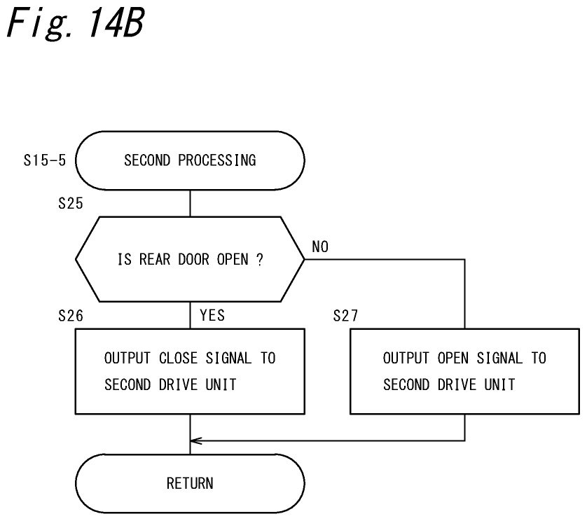

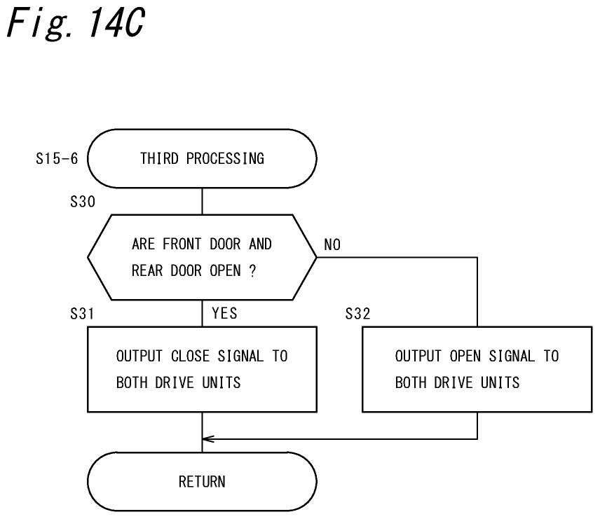

As shown in FIG. 14A, in the first processing, in step S20, the control unit 28 determines whether or not the front door 4A is in the open state by a signal of a not-shown detection switch or the like. When the front door 4A is in the open state, a door closing signal is output to the first drive unit 24A in step S21, and the process returns. When the front door 4A is in the close state, a door opening signal is output to the first drive unit 24A in step S22, and the process returns.

### Step S15-5: Second Processing

As shown in FIG. 14B, in the second processing, in step S25, the control unit 28 determines whether or not the rear door 4B is in the open state by a signal of a not-shown detection switch (not shown) or the like. When the rear door 4B is in the open state, a door closing signal is output to the second drive unit 24B in step S26, and the process returns. When the rear door 4B is in the close state, a door opening signal is output to the second drive unit 24B in step S27, and the process returns.

### Step S15-6: Third Processing

As shown in FIG. 14B, in the third processing, in step S30, the control unit 28 determines whether or not both of the front door 4A and the rear door 4B are in the open state by a signal of a not-shown detection switch or the like. When both of the doors 4A and 4B are in the open state, a door closing signal is output to both of the drive units 24A and 24B in step S31, and the process returns. When either one of the doors 4A and 4B is in the close state, a door opening signal is output to both of the drive units 24A and 24B in step S32, and the process returns.

In the third processing, when either one of the front door 4A and the rear door 4B is in the open state, the control unit 28 may output the closing signal to both of the drive units 24A and 24B. When the front door 4A is in the close state and the rear door 4B is in the open state, the opening signal may be output to the first drive unit 24A and the closing signal may be output to the second drive unit 24B, and when the front door 4A is in the open state and the rear door 4B is in the closed state, the closing signal may be output to the first drive unit 24A and the opening signal may be output to the second drive unit 24B.

The door opening and closing apparatus 10 of the present embodiment configured as described above has the following features.

The second detection range 16B of the second detection section 13B is set on the front side of the first detection range 16A of the first detection section 13 A. Therefore, when only the first detection section 13A detects the user, the control unit 28 can determine that the user is approaching from the rear. Further, when only the second detection section 13B detects the user, the control unit 28 can determine that the user is approaching from the front. Further, when both of the detection sections 13A and 13B detect the user, the control unit 28 can determine that the user is approaching from the side.

According to the direction from which the user is approaching, the control unit 28 executes one of the first processing of opening and closing the front door 4A by the first drive unit 24A, the second processing of opening and closing the rear door 4B by the second drive unit 24B, and the third processing of opening and closing both of the side doors 4A and 4B by both of the drive units 24A and 24B. Therefore, the user can open and close a desired one of the two side doors 4A and 4B by a simple movement of changing the direction from which the user is approaching.

When the vehicle body 2 is viewed from above, the first detection range 16A and the second detection range 16B partially overlap with each other. Therefore, the control unit 28 can reliably distinguish between the movement of the user approaching from the rear, the movement of the user approaching from the front, and the movement of the user approaching from the side.

In each of the detection ranges 16A and 16B, the start zone 18 and the trigger zone 19 are set, and the predetermined movements Ma to Mc include the first stage (first movement) in which the user in the start zone 18 moves to the trigger zone 19 and the second stage (second movement) in which the user in the trigger zone 19 returns to the start zone 18. That is, the user can open and close the target doors 4A and 4B by a simple movement of advancing and retreating within the detection ranges 16A and 16B. These predetermined movements Ma to Mc differ only in the direction of approaching the vehicle body 2, and the basic walking pattern is common. Therefore, the convenience of the user can be improved, and the erroneous operation against the intention of the user can be suppressed. In addition, the control program can be simplified, and the possibility of malfunction can be reduced.

The control unit 28 executes the first processing when it is determined that the first detection object is the moving object and the second detection object is the stationary object, executes the second processing when it is determined that the first detection object is the stationary object and the second detection object is the moving object, and executes the third processing when it is determined that both of the first detection object and the second detection object are moving objects. Therefore, the front door 4A is opened and closed when the user approaches from the rear, the rear door 4B is opened and closed when the user approaches from the front, and both of the doors 4A and 4B are opened and closed when the user approaches from the side. That is, because the doors 4A and 4B on the front side in the advancing direction of the user open and close, smooth door opening and closing control can be realized according to the intention of the user. In addition, because the doors 4A and 4B to be controlled can be determined depending on the moving direction of the user, the control can be simplified, and the possibility of malfunction can be reduced.

In other words, in the first stage, the control unit 28 determines which one of the first processing to the third processing is executed depending on which one of the start zone 18 of the first detection range 16A and the start zone 18 of the second detection range 16B the user is present in. Therefore, smooth opening and closing control can be realized according to the intention of the user. In addition, because which one of the first processing to the third processing is executed is determined in the first stage, the control program can be simplified, and the possibility of malfunction can be reduced.

Note that the door opening and closing apparatus 10 of the present invention is not limited to the configuration of the above embodiment, and various modifications can be made.

For example, as long as a state in which the first detection section 13A can detect the user, a state in which only the second detection section 13B can detect the user, and a state in which both of the detection sections 13A and 13B can detect the user can be configured, the arrangement of the detection ranges 16A and 16B does not need to be partially overlapped, and can be changed as necessary.

Although the control unit 28 is configured to determine the processing to be executed depending on whether the detection object that is detected by the detection sections 13A and 13B is the moving object or the stationary object, the determination as to which of the first processing to the third processing to be executed can be changed as necessary as long as the determination includes the determination of the direction from which the user who is the moving object is approaching.

The predetermined movements Ma to Mc for executing the first processing to the third processing are not limited to the configuration in which the basic walking pattern is common, and the walking patterns may be completely different, and the number of stages may also be different.

### REFERENCE SIGNS LIST

1: Vehicle, 2: Vehicle body, 3: Side part, 3a: Side step, 4A: Front door (front side door), 4B: Rear door (rear side door), 6: Wall, 10: Door opening and closing apparatus, 12: Detection unit (detection means), 13A: First detection section, 13B: Second detection section, 14: Wave transmitter, 15: Wave receiver, 16A: First detection range, 16B: Second detection range, 17: Approach region, 18: Start zone, 19: Trigger zone, 20A: First boundary line, 20B: Second boundary line, 22A to 22C: Detection section, 24A: First drive unit, 24B: Second drive unit, 25: Display unit, 26: Authentication unit, 28: Control unit, 29: Storage unit, 30: Measurement unit, 31: Determination unit, 32: Setting unit, 33: Calculation unit, Ma to Mc: Predetermined movement

1. A door opening and closing apparatus comprising:
a first drive unit that opens and closes a front side door;
a second drive unit that opens and closes a rear side door;
a first detection section that repeatedly detects a distance to a first detection object including a moving object present in a first detection range, the first detection range being set on a side of a vehicle body;
a second detection section that repeatedly detects a distance to a second detection object including the moving object present in a second detection range, the second detection range being set on the side of the vehicle body on a front side of the first detection range; and
a control unit that, when the moving object is determined based on a detection result of the first detection section and a detection result of the second detection section to have performed a predetermined movement having a plurality of stages, drives at least one of the first drive unit and the second drive unit to open and close a corresponding one of the front side door and the rear side door, wherein
the control unit determines that, based on the detection result of the first detection section and the detection result of the second detection section, from which one of a rear, a front, and the side of the vehicle body the moving object is approaching, and according to a result of the determination, executes one of first processing of driving only the first drive unit, second processing of driving only the second drive unit, and third processing of driving both of the first drive unit and the second drive unit.

2. The door opening and closing apparatus according to claim 1, wherein the first detection range and the second detection range partially overlap with each other when the vehicle body is viewed from above.

3. The door opening and closing apparatus according to claim 1, wherein
the first detection range and the second detection range each have a start zone and a trigger zone set, the trigger zone being located closer to the vehicle body than the start zone, and
the predetermined movement includes a first stage in which the moving object in the start zone moves to the trigger zone and a second stage in which the moving object in the trigger zone returns to the start zone.

4. The door opening and closing apparatus according to claim 3, wherein, in the first stage, the control unit determines which one of the first processing to the third processing is executed depending on which one of the start zone of the first detection range and the start zone of the second detection range the moving object is present in.

5. The door opening and closing apparatus according to claim 1, wherein
the control unit is configured to:
determine whether the first detection object is the moving object or the stationary object based on the detection result of the first detection section, and also determines whether the second detection object is the moving object or the stationary object based on the detection result of the second detection section, and
execute the first processing when it is determined that the first detection object is the moving object and the second detection object is the stationary object, execute the second processing when it is determined that the second detection object is the moving object and the first detection object is the stationary object, and execute the third processing when it is determined that both of the first detection object and the second detection object are the moving objects.
